(19) United States
(12) Patent Application Publication
(10) Pub. No.: US 2004/0013828 A1
(43) Pub. Date: Jan. 22, 2004

(54) Pack comprised of flexible support suited for taking up liquids, care set containing this pack, method for producing a pack and cosmetic treatment method involving the use of this pack.

(76) Inventor: Petra Tewes-Schwarzer, Senden (DE)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/399,984

(22) PCT Filed: Mar. 29, 2001
(86) PCT No.: PCT/EP01/03623

(30) Foreign Application Priority Data
Apr. 10, 2000 (DE) 10017530.9

(51) Int. Cl. F16L 1/00

(52) U.S. Cl. 428/34.1; 428/137

(57) ABSTRACT

The invention relates to a pack made of a flexible support that is suitable for picking up liquids and/or that is absorbent, consisting of at least one sheet-like component (2, 3), which is characterized in that at least one of the components (2) consists of at least two subcomponents (4, 5), which are detachably joined to each other (8, 9, 10), a care set containing a pack, as well as the production and the use of said pack.

The invention relates to a pack made of a flexible support, to a care set containing this pack, to a process for the production of such a pack as well as to a method for cosmetic treatment using this pack.

A pack as defined in the present invention is a pack placed onto the body surface, for example, a face pack, an eye pack, an eyelid pack, a chest pack, a neck pack, a décolleté pack or a pack applied to the body extremities. Preferably, the pack according to the invention refers to a face pack.

According to a general definition, a pack also refers to a special care product that is placed hot or cold onto the skin, especially the skin of the face, and that is removed again after a certain application time. This is meant to supplement and promote general skin care.

Moreover, said pack can topically apply biologically active ingredients such as cosmetics and/or pharmaceuticals in order to achieve preventive care and cosmetic treatment of the skin, prophylaxis and therapy of dermatitis and treatment of injuries to the body surface. In the case of therapeutic packs, the pack remains on the body surface to be treated for a prolonged period of time and is entirely or partially broken down by body fluids.

Such packs on the basis of freeze-dried biomatrices are the subject matter of German Preliminary Published Application No. 40 28 622 as well as German Preliminary Published Application No. 43 28 329. The packs used here are normally made of sheet-like materials that are approximately the size of a DIN A4 sheet of paper and that first have to be folded and cut to size prior to use so that the face pack can be adapted to the contours of the face. Such a procedure, however, is technically demanding and time-consuming for the person administering the treatment.

Consequently, the objective of the present invention is to create a pack made of a flexible support that is suitable for picking up liquids and/or that is absorbent, consisting of at least one sheet-like component 2 that is shaped more conveniently in terms of its application.

This objective is achieved in that at least one of the above-mentioned components 2 consists of at least two subcomponents 4, 5, 6, which are detachably connected to each other 8, 9, 10.

Thus, the present invention relates to a pack made of a flexible support that is suitable for picking up liquids and/or that is absorbent, consisting of at least one sheet-like component 2, which is characterized in that at least one of the components 2 consists of at least two subcomponents 4, 5, 6, which are detachably joined to each other 8, 9, 10.

According to a preferred embodiment of the present invention, at least one of the components 2 of the support has at least one opening 12, 13 and/or a detachable connection, 11.

Here, it is preferred that the openings are either already present in the component 2 of the support 11, 12 itself and/or are formed when the product is placed onto the face, 11.

According to another preferred embodiment of the pack according to the invention, the support has a thickness of about 0.1 mm to 5 mm, preferably, however, 0.5 mm to 2.0 mm.

According to another preferred embodiment, the support has a coating on one of the two surfaces of the components 2, 3. This coating is provided with an adhesive layer by means of which the coating is affixed to the support. The adhesive layer can be designed in such a way that, upon use, that is to say, upon coming into contact with liquid, the coating remains firmly attached to the support or the coating separates from the support after a certain period of time. The coating and the adhesive layer consist of a material that does not irritate the skin and, on the side facing away from the support, they form a backing layer, on the one hand, for purposes of facilitating the handling of the pack and on the other hand, for providing an additional occlusion effect which, for example, promotes the penetration into the skin by the active ingredients that had previously been incorporated into the support. Moreover, this occlusion brings about a greater hydration of the skin.

Examples of coating materials that can be used are the materials mentioned in the reprint of the Bundesgesundheitsblatt (German Federal Health Bulletin; 39^{th} Volume, March 1996, Issue 3, reprint published by the Robert-Koch Institute, the German Federal Institute for Infectious Diseases and Non-contagious Diseases, the German Federal Institute for Consumer Health Protection and Veterinary Medicine, the German Federal Institute for Drugs and Medical Products and the Institute for Water, Soil and Air Hygiene (German Federal Environmental Agency) “Information on the evaluation of toilet paper and information on the evaluation of intimate hygienic products”). Specifically, these materials are, for example, polypropylene, polyethylene, viscose, polyester, softening agents, cellulose, wood pulp, cotton, polyurethane.

Moreover, other possibilities are films of animal origin, for instance, collagen films or films of biotechnological origin such as, for example, paramylon films.

The adhesive layer consists, for example, of thermoplastic caoutchouc, resins, waxes and oils or fibrin. As an alternative, the above-mentioned layer is applied in a generally known manner, for example, by spraying a solution onto it or by dispersing a polymer. Finally, the layer can also be mechanically affixed to the support by means of embossing, stitching or similar processes.

According to another preferred embodiment, the support of the pack according to the invention essentially contains a biomatrix of plant and/or animal origin.

A biomatrix of plant origin refers to natural polysaccharides, for example, on the basis of pectins, alginates, carrageen, agar and carob seed flour as well as modified polysaccharides, for instance, on the basis of cellulose derivatives such as cellulose ethers. For information on further materials of these biomatrices on the basis of plant substances, reference is made to German Preliminary Published Application No. 43 28 329.

According to a preferred embodiment of the present invention, the pack according to the invention contains a support on the basis of collagen, that is to say, of animal origin. For further information, reference is made, for example, to German Preliminary Published Application No. 40 28 622 as well as to German Patent No. 32 03 957.

According to another preferred embodiment, the support in the pack according to the invention also contains biologically active substances such as auxiliaries and additives. These substances are generally known, for example, from German Preliminary Published Application No. 43 28 329, column 3, line 5 to column 6, line 55.

According to another preferred embodiment, the pack according to the invention is a therapeutic or cosmetic pack.

The present invention is also based on the objective of providing a care set containing a pack according to the above-mentioned claims.

A liquid in the sense of the above-mentioned cosmetic treatment method refers to hydrophilic liquids on the basis of water as well as alcoholic lotions or finally also lipophilic liquids such as vegetable or synthetic oils.

In addition to the pack, such a care set according to the invention can contain a water-based liquid of the type used in cosmetic care or else it can contain an active lotion or a gel. Additional constituents of such a care set can be active ingredient solutions, for example, in ampoule form, sponges or cosmetic brushes.

The present invention will now be explained in greater depth with reference to a face pack.

The following is shown:

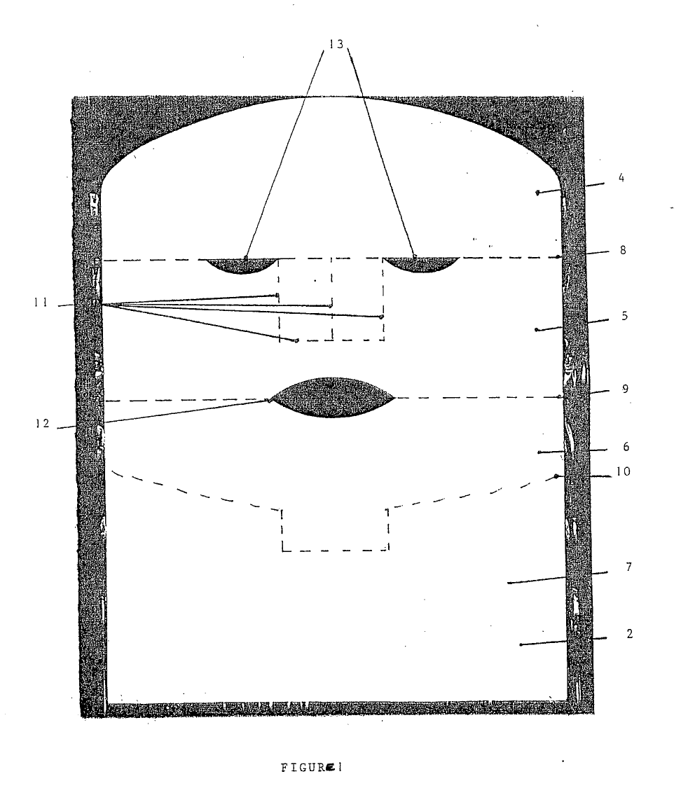

FIG. 1—a first preferred embodiment of the pack according to the invention,

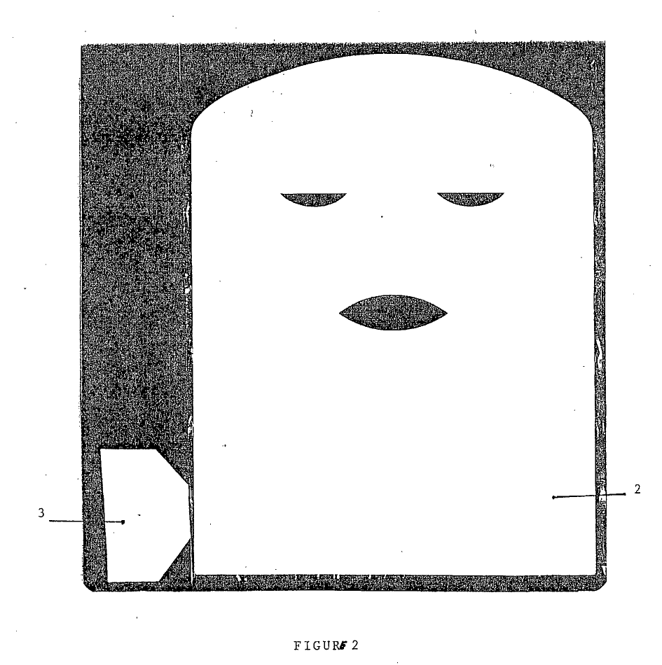

FIG. 2—another preferred embodiment of the pack according to the invention.

In the case of the pack according to FIG. 1, the support made up of a sheet-like component 2 consists of several subcomponents, namely, the forehead part 4, the cheek part 5, the chin part 6 and the neck part 7, which are initially detachably connected to each other. In component 2, there are already punched-out areas for the mouth 12 as well as for the eyes 13 and the forehead part and the cheek part are separated at the perforation 8, while the cheek part and the chin part are separated at the perforation 9 and the chin part and the neck part are separated at the perforation 10.

Another preferred embodiment of the pack is shown in FIG. 2 with component 2 (not illustrated in full detail) as well as component 3, which is configured as a nose part here.

The present invention is also based on the objective of providing a process for the production of the above-mentioned pack. Such a process for the production of the pack according to the invention of the type described above encompasses the provision of components 2, optionally provided with a coating, the provision of at least one weakened line 8, 9, 10 on the component 2 as well as optionally the provision of openings 11, 12 in the component.

Finally, the present invention is based on the objective of providing a method for the cosmetic treatment of the surface of the body using a pack of the type described above.

Finally, the subject matter is a method for the cosmetic treatment of the surface of the body using a pack of the type described above, comprising

(a) the separation of detachably connected subcomponents 4, 5, 6 from component 2,

(b) the contacting of the surface of the body with an effective amount of a liquid,

(c) the application of the first subcomponent onto at least one part of the surface of the body and moistening it with liquid,

(d) the application of another component onto the surface of the body and

(e) the repetition of step (c),

(f) the repetition of the above-mentioned steps (d) to (e), until all components of the subcomponents have been applied to the surface of the body.

1. A pack made of a flexible support that is suitable for picking up liquids and/or that is absorbent, consisting of at least one sheet-like component, characterized in that at least one of the above-mentioned components consists of at least two subcomponents, which are detachably connected to each other (8, 9, 10).

2. The pack according to claim 1, characterized in that it is a face pack.

3. The pack according to claims 1 or 2, characterized in that at least one of the components (2) of the support has at least one opening (11, 12, 13).

4. The pack according to claims 1 or 2, characterized in that the openings are either already present in the component (2) of the support itself (12, 13) and/or are formed when the product is placed onto the surface of the body (11).

5. The pack according to the preceding claims, characterized in that the support has a thickness of about 0.1 mm to 5 mm, preferably 0.5 mm to 2 mm.

6. The pack according to the preceding claims, characterized in that the support has a coating on one of the two surfaces of the components.

7. The pack according to one of the preceding claims, characterized in that the support essentially contains a biomatrix of plant and/or animal origin.

8. The pack according to the preceding claims, characterized in that the support contains a biomatrix on the basis of collagen.

9. The pack according to the preceding claims, characterized in that the support also contains biologically active substances as well as auxiliaries and additives.

10. The pack according to the preceding claims, characterized in that it is a therapeutic or cosmetic pack.

11. A care set containing a pack according to claims 1 to 10.

12. A process for the production of a pack according to any one of the claims 1 to 10, by
(a) providing components (2, 3), optionally provided with a coating,
(b) providing at least one weakened line (8, 9, 10) on the component (2)
(c) optionally providing openings (11, 12, 13) in the component.

13. A process for the cosmetic treatment of the surface of the body using a pack according to claims 1 to 10, comprising
(a) the separation of detachably connected subcomponents (4 to 6) from component (2),
(b) the contacting of the surface of the body with an active amount of a liquid,
(c) the application of a first subcomponent on at least one part of the surface of the body and moistening it with liquid,
(d) the application of another component onto the surface of the body and
(e) the repetition of step (c),
(f) the repetition of the above-mentioned steps (d) to (e), until all components of the subcomponents have been applied to the surface of the body.

14. Apack for use on a human body, comprising:
a support component that is flexible and absorbent; and
a sheet component mounted to the support, wherein the sheet component has a plurality of detachable subcomponents, and each subcomponent is configured to overlay a corresponding portion of the body such that each subcomponent can follow the specific contour of the corresponding body portion.

15. The pack as defined in claim 14, wherein the pack is configured for use on a human face such that the plurality of subcomponents includes a first subcomponents that is configured to overlay a portion of the face, and a second subcomponent that is configured to overlay a different portion of the face, whereby the subcomponents overlay the corresponding face portions such that the contour of the face is closely followed.

16. The pack as defined in claim 14, wherein at least one of the subcomponents defines an aperture, whereby a portion o the body is not overlaid by the subcomponents in a region adjacent to the aperture.

17. The pack as deifined in claim 16, wherein the aperture is performed in the support or is formed by contacting the sheet against the body.

18. The pack as defined in claim 14, wherein the sheet component has a thickness in a range of from about 0.1 millimeters to about 5 millimeters.

19. The pack as defined in claim 14, wherein the sheet component has a thickness in a range of from about 0.5 millimeters to about 2 millimeters.

20. The pack as defined in claim 14, wherein the support is coated.

21. The pack as defined in claim 14, wherein the support comprises a collagen biomatrix.

22. The pack as defined in claim 14, wherein the support comprises a biologically active substance, an auxiliary and an additive.

23. A human care system, comprising:
a pack configured for use on a human face, the pack comprising:
a coated support component having a collagen biomatrix, and that is flexible, absorbent, and has a thickness in a range of from about 0.1 millimeters to about 5 millimeters, and that defines an aperture, the aperture being preformed in the support or being formed by contacting the sheet against the body; and
a sheet component mounted to the support, wherein the sheet component has a plurality of subcomponents, and the subcomponents are detachably connected to each other.

24. A process for producing a pack for use on a human body, comprising:
(a) providing a sheet mounted to a support component;
(b) forming at least one weakened line in the sheet; and
(c) forming an optional plurality of openings in the sheet.

25. The process as defined in claim 24, further comprising coating the sheet component.

26. A process for the cosmetic treatment of a surface of a body using a pack comprising:
(a) separating detachably connected subcomponents from a sheet;
(b) contacting the surface of the body with an active amount of a liquid;
(c) applying a moisten one of the detached subcomponents to the surface of the body.
(d) applying another moistend subcomponents to the surface of the body and;
(e) repeating of the above-mentioned step (c) to (d), until all of the subcomponents have been applied to the surface of the body.

27. The process as defined in claim 26, wherein step (c) comprises forming an aperture in the subcomponent by contacting the subcomponent with the body surface.

28. A pack for use on a surface of a human body, comprising:
a flexible support component; and
a sheet secured to the support component, wherein the sheet has a plurality of subcomponents, and each subcomponent is configured to overlay a corresponding portion of the body surface that each subcomponent can follow specific contour of the corresponding body portion, whereby a surface of each subcomponent intimately contacts the corresponding portion of the body surface.

29. The pack as defined in claim 28, wherein the sheet is secured to the support component by an adhesive layer, the adhesive layer being generally non-irritating to human skin and forming a generally occlusive layer that blocks migration of active ingredients adsobed by the sheet.

30. The pack as defined in claim 29, wherein the adhesive layer is a material selected from the group consisting of thermoplastic caoutchouc, resin, wax, oil and fibrin.

31. The pack as define in claim 28, wherein the sheet is coated by a film formed of a material selected from the group consisting of collagen and paramylon.

32. The pack as defined in claim 28, wherein the sheet is coated by a material selected from the group consisting of polypropylene, viscose, polyester, softening agent, cellulose, wood pulp, cotton and polyurethane.

33. The pack as defined in claim 28, wherein the sheet comprises a polysaccharide biomatrix material.

34. The pack as defined in claim 33, wherein the polysaccharide is derived from a material selected from the group consisting of pectin, alginate, carrageen, agar, carob seed flour, and cellulose derivatives.
